(19) United States
(12) Patent Application Publication
(10) Pub. No.: US 2014/0108160 A1
(43) Pub. Date: Apr. 17, 2014

(54) PRESENTING SPONSORED AND UNSPONSORED CONTENT IN SEARCHES OF TRAVEL PRODUCTS

(71) Applicant: GetGoing, Inc., San Francisco, CA (US)

(72) Inventors: Ilya Gluhovsky, Daly City, CA (US); Alek Vernitsky, San Francisco, CA (US); Alek Strygin, Foster City, CA (US)

(73) Assignee: GetGoing, Inc., San Francisco, CA (US)

(21) Appl. No.: 14/051,233

(22) Filed: Oct. 10, 2013

Related U.S. Application Data
(60) Provisional application No. 61/712,349, filed on Oct. 11, 2012.

(51) Int. Cl. G06Q 30/02

(52) U.S. Cl. CPC G06Q 30/0275
USPC 705/14.71

(57) ABSTRACT

The disclosed embodiments provide a system that processes a query from a user. During operation, the system obtains a set of travel products matching the query. Next, the system provides a minimum bid for each of the travel products and enables additional bidding on the travel products by a set of suppliers associated with the travel products. The system then generates a ranking of the travel products based on the minimum bid, the additional bidding, and a set of quality scores associated with the travel products. Finally, the system provides the travel products to the user based on the ranking.

### RELATED APPLICATIONS

This application claims the benefit of U.S. Provisional Application No. 61/712,349, Attorney Docket Number GG12-1008PSP, entitled “Method and Apparatus for Creating Flight Search Sponsored Post and Marketplace,” by inventors Ilya Gluhovsky, Alek Vernitsky and Alek Strygin, filed 11 Oct. 2012, which is incorporated herein by reference.

The subject matter of this application is related to the subject matter in a co-pending non-provisional application by inventors Alek Vernitsky, Alek Strygin and Ilya Gluhovsky, entitled “System and Method for Facilitating the Purchase of a Travel Itinerary Subject to Destination Uncertainty,” having Ser. No. 13/656,458 and filing date 19 Oct. 2012 (Attorney Docket No. GG12-1001).

The subject matter of this application is also related to the subject matter in a co-pending non-provisional application by inventors Alek Vernitsky, Ilya Gluhovsky and Alek Strygin, entitled “Using Multi-Destination Searches to Facilitate the Purchase of Travel Itineraries,” having serial number TO BE ASSIGNED, and filing date TO BE ASSIGNED (Attorney Docket No. GG12-1007).

### BACKGROUND

1. Field

The disclosed embodiments relate to online advertising. More specifically, the disclosed embodiments relate to techniques for presenting sponsored and unsponsored content in searches of travel products.

2. Related Art

Content sponsorship and/or online advertising are associated with a significant portion of Internet activity. Common practices include advertising through sponsored search results, banner or display advertisements, social media, mobile applications, emails, and/or crowd-sourcing. In turn, online advertising may allow various parties to earn income, provide information, and/or sell products or services. For example, a company may run advertising campaigns on a search engine, social media website, and/or e-commerce website to increase exposure to the goods, services, and/or information advertised in the advertising campaigns. In turn, the website may receive revenue from the advertiser for showing advertisements from the advertising campaigns to users, causing users to click on the advertisements, and/or causing the users to perform other actions related to the advertisements (e.g., registering for a user account with the advertiser, filling out a survey, etc.).

To allow multiple advertisers to advertise within a limited space on a website, the website may run an advertising auction that sells online advertisement slots based on bids from the advertisers. For example, a search engine may accept a query from a user and return links to websites and/or other content that match the query in a set of search results. The search engine may also display a limited number of sponsored search links, which are paid advertisements. Such advertisements are typically located in a dedicated region of the web page containing the search results (e.g., top, side, bottom) and thus are clearly distinguishable from the search results.

To participate in the advertising auction, an advertiser may place a bid for each submitted advertisement on each of a set of keywords relevant to the advertised product or service. For example, a tennis store may bid $0.50 on “tennis racquet,” $0.15 on “Roger Federer,” and/or other amounts on other keywords related to tennis. When one of the keywords matches a user's search query with a search engine, the tennis store's advertisement may be considered for display in the sponsored search results based on the tennis store's bid(s), the relevance of the advertisement to the user, and/or the bids of other advertisers competing for advertising to the online user based on the search query.

Online advertisements may also target a user contextually. For example, a hockey equipment seller may bid for placement of an advertisement on a professional hockey league website. Similarly, a social media website may display advertisements to a user based on both semantic (e.g., keywords) and social (e.g., the user's friends' actions) context. As with sponsored search results, contextual placement of advertisements may be based on bids from advertisers vying for the contextual placement.

During an online advertising auction for running advertisements on a website, advertisers may compete for placement of sponsored content in specific positions or slots on the website, which may have a significant effect on a user's attention. For example, the top advertisement slot may have a click-through rate (CTR) up to an order of magnitude higher than the bottom advertisement slot in a search results page. Since better-placed advertisements may derive higher utility, higher slots may be more expensive than lower slots.

Consequently, the website may adopt a generalized second price (GSP) auction for placing the advertisements. During the GSP auction, advertisements are placed in order of decreasing bid, each advertiser is charged the next highest bid plus an increment for each click, and the lowest bidder is charged the reserve price of the auction. By convention, the positions are numbered from the top. For example, if three advertisers bid for “tennis racquet” with bids of $0.40, $0.50, and $0.20, the advertisers' ads are shown in the second (e.g., middle), first (e.g., top), and third (e.g., bottom) positions, respectively. The advertisers are also charged a respective $0.21, $0.41, and $0.10 per click if the auction's reserve price is $0.10.

Another common feature is to place and charge for advertisements based on quality scores as well as advertisers' bids. For example, in a pay-per-click (PPC) model, the revenue obtained from an advertisement is the cost of each click on the advertisement multiplied by the advertisement's CTR. As a result, placing higher quality advertisements may result in higher revenue from the advertisements. Presently, search engines adopt a simplified model where, for each query s, each advertisement a receives a quality score qs(a) with the property that for any two ads a′ and a″ and an ad position r:

c(s,r,a′)/c(s,r,a″)=qs(a′)/qs(a″)

In the above equation, c(s, r, a) may represent the CTR of advertisement a when shown for query s in position r. The ads are then displayed in the order of decreasing adjusted bids defined as the products of bids and quality scores, and the advertisers are charged the minimum bid required to beat the next-highest bid.

When placing a bid, an advertiser faces a tradeoff of bidding high and receiving many expensive clicks or bidding low and receiving few cheap clicks. Such a tradeoff may apply to the GSP auction, with or without quality scores.

Consequently, processing of search queries may be facilitated by techniques for facilitating the presentation of both sponsored and unsponsored content in search results of the search queries.

### SUMMARY

The disclosed embodiments provide a system that processes a query from a user. During operation, the system obtains a set of travel products matching the query. Next, the system provides a minimum bid for each of the travel products and enables additional bidding on the travel products by a set of suppliers associated with the travel products. The system then generates a ranking of the travel products based on the minimum bid, the additional bidding, and a set of quality scores associated with the travel products. Finally, the system provides the travel products to the user based on the ranking.

In some embodiments, the system also calculates a set of costs-per-action (CPAs) associated with the travel products based on the additional bidding by the set of suppliers.

In some embodiments, calculating the set of CPAs associated with the travel products based on the additional bidding by the set of suppliers involves calculating a cost-per-action (CPA) for a subset of the travel products associated with additional bids from a first supplier based on an additional bid for a travel product from a second supplier that is next lowest in the ranking from the subset of the travel products.

In some embodiments, the system also calculates the set of quality scores based on one or more search parameters of the query, one or more attributes associated with the travel products, one or more attributes of the user, and/or one or more attributes associated with the suppliers.

In some embodiments, obtaining the set of travel products matching the query from the user involves performing a search of the travel products using a set of search parameters from the query, and enabling addition of one or more travel products that violate one or more of the search parameters to the set of travel products.

In some embodiments, the addition of the one or more travel products that violate the one or more of the search parameters is associated with at least one of a limited number of violations and a margin of violation.

In some embodiments, generating the ranking of the travel products based on the minimum bid, the additional bidding, and the set of quality scores involves:

(i) for each travel product from the set of travel products:
a. adding the minimum bid to an additional bid for the travel product to obtain an overall bid for the travel product, and
b. multiplying the overall bid by a quality score of the travel product to obtain a rank value for the travel product; and

(ii) ordering the travel products by the rank value.

In some embodiments, the query is associated with at least one of a set of destination preferences and a destination uncertainty.

In some embodiments, the additional bidding is placed on a subset of the travel products associated with a supplier, an origin, a destination, a route, a schedule, a specific date, a date range, a departure and/or arrival time window, a marketing carrier, an operating carrier, a validating carrier, a traveler type, an amount of inventory, a travel product type, a user preference, a user action, a destination preference, an alternative destination, a modification to the query, and/or a search parameter of the query.

### BRIEF DESCRIPTION OF THE FIGURES

FIG. 1 shows a schematic of a system in accordance with the disclosed embodiments.

FIG. 2 shows a system for processing a query from a user in accordance with the disclosed embodiments.

FIG. 3 shows the exemplary processing of a query from a user in accordance with the disclosed embodiments.

FIG. 4 shows a flowchart illustrating the processing of a query from a user in accordance with the disclosed embodiments.

FIG. 5 shows a flowchart illustrating the process of generating a ranking of travel products in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

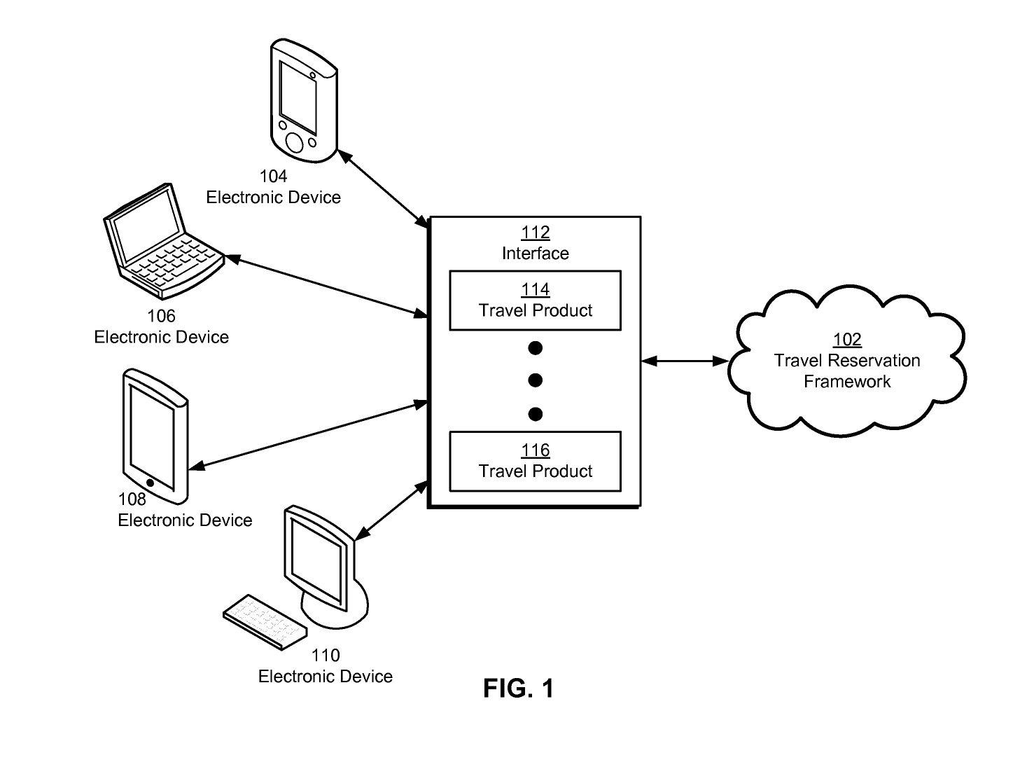

The disclosed embodiments provide a method and system for facilitating the purchase of travel products such as flights, hotels, rental cars, cruises, tours, and/or travel packages. As shown in FIG. 1, a set of travel products 114-116 may be searched through an interface 112 that is accessed by a set of users (e.g., “buyers”) through a set of electronic devices 104-110. For example, interface 112 may be a graphical user interface (GUI), web-based user interface, touch-based user interface, and/or other type of user interface that is provided by a web browser, mobile application, native application, and/or other application executing on a mobile phone, personal computer, laptop computer, personal digital assistant, tablet computer, portable media player, and/or other type of network-enabled electronic device.

Travel products 114-116 may be provided by a travel reservation framework 102 that is accessed through interface 112. For example, travel reservation framework 102 may allow the users to specify an origin, a destination, a departure date, a return date, flexible dates, a length of stay, a number of travelers, a traveler type (e.g., adult, child, senior, etc.), a level of quality, a type of travel product (e.g., flight, hotel, rental car, cruise, tour, travel package, etc.), and/or other search parameters related to booking travel products 114-116.

After obtaining the search parameters from a user through the user's electronic device (e.g., electronic devices 104-110) and interface 112, travel reservation framework 102 may perform searches of multiple airlines, online travel agencies, search engines, and/or other travel booking sources for travel products 114-116 that match the search parameters. Travel reservation framework 102 may then provide information related to the matching travel products 114-116 (e.g., name, location, price, schedule, operating carrier, supplier, star rating, user rating, etc.) as search results to the user through interface 112. After the user has selected a suitable travel product from the search results, travel reservation framework 102 may allow the user to purchase the travel product, either through interface 112 or by redirecting the user to websites and/or other booking mechanisms of the airlines, online travel agencies, and/or other travel-related service providers.

In one or more embodiments, travel reservation framework 102 enables sponsorship of travel products 114-116 by suppliers of travel products 114-116. Because travel products 114-116 are returned as organic search results instead of sponsored advertisements, such sponsorship may be used to reorder travel products 114-116 within the search results and/or include additional travel products that would not normally match the user's query in the search results. In turn, sponsored travel products may not be separated from unsponsored travel products in the search results, and both sponsored and unsponsored travel products 114-116 may compete for placement in the same auction, as described below.

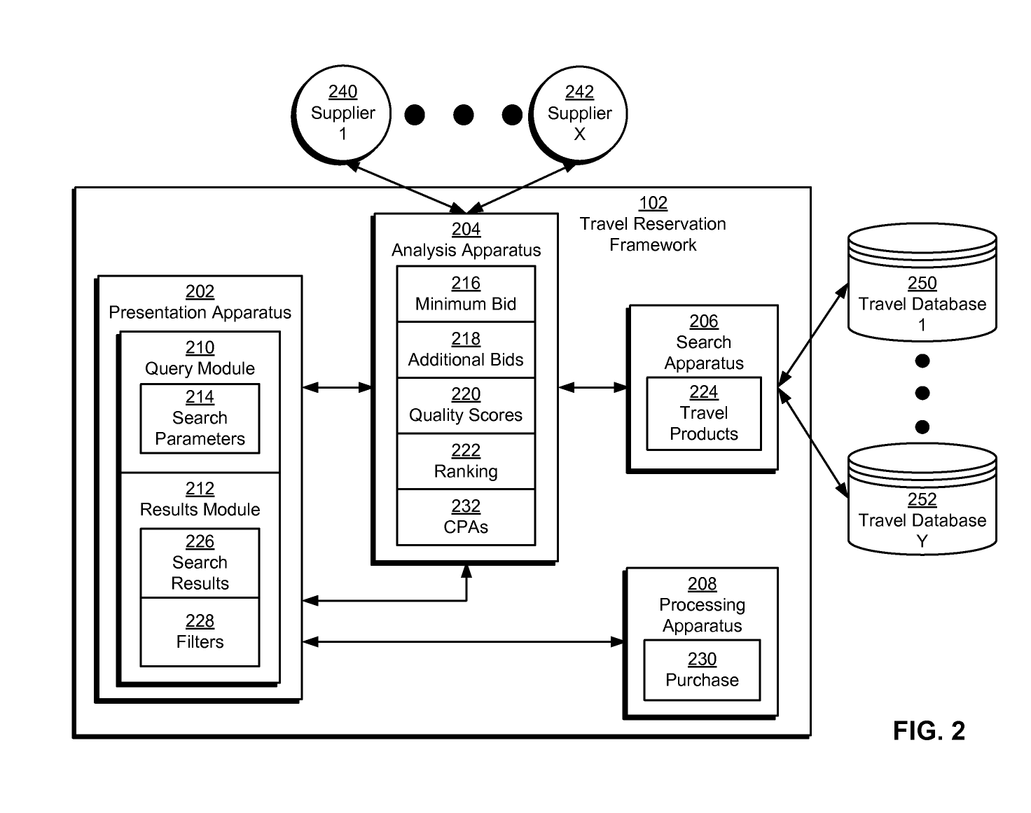

FIG. 2 shows a system for processing a query from a user in accordance with the disclosed embodiments. The query may be obtained by a query module 210 provided by a presentation apparatus 202 in travel reservation framework 102 as a set of search parameters 214 from a user. To interact with the user, presentation apparatus 202 may provide a user interface that is accessed through an electronic device of the user, such as interface 112 of FIG. 1.

Search parameters 214 may describe the attributes of travel products (e.g., travel products 114-116 of FIG. 1) to be searched using the query. For example, search parameters 214 may identify the types of travel products to be searched, such as flights, hotels, cruises, rental cars, tours, and/or travel packages. Search parameters 214 may also include specific dates, flexible dates, and/or date ranges, as well as locations (e.g., origin, destination, etc.) associated with the travel products. Search parameters 214 may further specify a level of quality (e.g., class of service, star rating, type of rental car, etc.), a price and/or price range, and/or a supplier (e.g., operating carrier, brand, airline alliance, hotel group, rental car company, travel agency, tour operator, etc.) associated with the travel products. In addition, search parameters 214 may include a number of passengers or guests and/or types of passengers or guests (e.g., adults, children, seniors, etc). Finally, search parameters 214 may be related to schedules associated with the travel products, such as departure times, arrival times, total travel time, numbers of stops, lengths of the stops, and/or lengths of stay.

In one or more embodiments, search parameters 214 include one or more destination preferences that describe a set of destinations to be searched using the query. The destination preferences and/or other search parameters 214 may be matched to a set of destinations and available travel itineraries (e.g., flights) associated with the destinations, which are provided to the user as a set of search results 226. As a result, the destination preferences may enable multi-destination searches for the travel itineraries, rather than a series of searches for travel itineraries associated with individual origin-destination pairs. Multi-destination searches for facilitating the purchase of travel itineraries are described in a co-pending non-provisional application by inventors Alek Vernitsky, Ilya Gluhovsky and Alek Strygin, entitled “Using Multi-Destination Searches to Facilitate the Purchase of Travel Itineraries,” having serial number TO BE ASSIGNED, and filing date TO BE ASSIGNED (Attorney Docket No. GG12-1007), which is incorporated herein by reference.

In one or more embodiments, search parameters 214 are further associated with an “alternative destinations” mechanism for purchasing a travel itinerary. The “alternative destinations” mechanism may allow the user to add two or more travel itineraries to different destinations to a shopping cart (e.g., provided by a processing apparatus 208 of travel reservation framework 102) and commit to purchasing at least one of the selected travel itineraries. Because multiple destinations are an inherent part of the “alternative destinations” mechanism, use of the “alternative destinations” mechanism may be facilitated by conducting one or more multi-destination searches of available discounted travel itineraries through travel reservation framework 102. The user may then add different destinations to the shopping cart for use with the “alternative destinations” mechanism using search results 226 from the multi-destination searches.

Travel reservation framework 102 may then select one or more of the destinations in the shopping cart and process a purchase (e.g., purchase 230) of a travel itinerary associated with the selected destination(s) for the user before revealing the purchased travel itinerary to the user. Using an “alternative destinations” mechanism to purchase a travel itinerary is described in a co-pending non-provisional application by inventors Alek Vernitsky, Alek Strygin and Ilya Gluhovsky, entitled “System and Method for Facilitating the Purchase of a Travel Itinerary Subject to Destination Uncertainty,” having Ser. No. 13/656,458 and filing date 19 Oct. 2012 (Attorney Docket No. GG12-1001), which is incorporated herein by reference.

After the user submits search parameters 214 in the query, a search apparatus 206 in travel reservation framework 102 may obtain a set of travel products 224 matching the query. During the search, search apparatus 206 may query multiple travel databases (e.g., travel database 1 250, travel database y 252) and aggregate results from the travel databases as the set of matching travel products 224. For example, search apparatus 206 may search multiple travel provider websites, global distribution systems (GDSes), central reservation systems (CRSes), online travel agencies, travel providers, and/or other sources of flights, cruises, rental cars, hotels, tours, and/or travel packages to obtain available travel products 224.

A results module 212 in presentation apparatus 202 may then provide the matching travel products 224 as search results 226 for the query to the user. Search results 226 may be grouped and/or ordered in a number of ways. For example, search results 226 for a multi-destination search of travel itineraries may be provided as a set of vertically stacked “blocks,” with each block containing a summary of available travel itineraries (e.g., number of flights, cheapest flight, etc.) to the corresponding destination. Alternatively, search results 226 for single or multi-destination searches may include a list of travel itineraries to matching destinations that are sorted by price, schedule, number of stops, operating carrier, and/or another attribute.

Results module 212 may also update the grouping, ordering, and/or appearance of search results 226 based on input from the user. First, results module 212 may provide a set of filters 228 for updating and/or filtering search results 226. For example, filters 228 may be used by the user to filter and/or sort search results 226 for travel itineraries by departure time, arrival time, total travel time, number of stops, price, operating carrier, operating carrier alliances, destinations visited by the user's contacts (e.g., friends, family members, acquaintances, etc.), destinations visited by the user, geographic region, name, and/or other travel options or attributes associated with the travel itineraries. Filters 228 may also be preset based on the user's implicit and/or explicit preferences, as obtained from the user's settings and/or previous interaction with travel reservation framework 102. For example, filters 228 may be set to prevent lengthy travel itineraries from being shown in search results 226 if the user is explicitly or implicitly sensitive to trip duration.

Results module 212 may also allow the user to modify the displayed search results 226. For example, results module 212 may provide a field that may be used to add specific destinations, types of travel products, suppliers of the travel products, and/or other attributes associated with travel products 224 to search results 226 (e.g., thus triggering a search of additional travel products 224 matching the attributes). The user may then manipulate the additional search results 226 within results module 212. On the other hand, the user may hide or remove one or more travel products from search results 226 if the travel product(s) are not relevant to the user's travel plans and/or preferences. Finally, the user may modify the query and/or search parameters 214 within results module 212 to obtain a new set of search results 226 matching the modified query and/or search parameters 214.

Moreover, results module 212 may automatically update search results 226 based on the user's actions and/or interaction with presentation apparatus 202. For example, the user's addition of an attribute and/or travel product to search results 226 may cause similar travel products to appear higher in search results 226 and/or trigger the addition of the similar travel products to search results 226, if the similar travel products weren't already in search results 226.

The user may thus browse, filter, sort, and/or modify search results 226 in results module 212 until the user finds a travel product that matches the user's budget, schedule, and/or other travel preferences. The user may select the travel product in results module 212, and a processing apparatus 208 in travel reservation framework 102 may process a purchase 230 of the travel product for the user. For example, presentation apparatus 202 and/or processing apparatus 208 may confirm the details of purchase 230 (e.g., dates, schedule, location(s), supplier, type of travel product, number of travelers, prices, etc.) with the user, obtain payment (e.g., credit card, debit card, electronic check, online payment) information from the user, and perform purchase 230 by booking the travel product using the payment information. Alternatively, presentation apparatus 202, processing apparatus 208, and/or another component of travel reservation framework 102 may redirect the user to a third-party website and/or booking mechanism through which the user may purchase 230 the travel product.

As mentioned above, travel reservation framework 102 may include functionality to provide both sponsored and unsponsored content in search results 226. More specifically, travel reservation framework 102 may allow suppliers (e.g., supplier 1 240, supplier x 242) of travel products 224 possibly provided as organic search results 226 to bid on their travel products. Travel products with bids from the suppliers (e.g., sponsored content) may then compete with travel products without bids (e.g., unsponsored content) for placement and/or inclusion in search results 226. In other words, both sponsored and unsponsored content may be selected for placement and/or inclusion in search results 226 using an auction such as a generalized second-price (GSP) auction.

As shown in FIG. 2, an analysis apparatus 204 in travel reservation framework 102 may provide a minimum bid 216 for each travel product from the set of matching travel products 224, regardless of the subsequent sponsorship of the travel product by the travel product's supplier. For example, analysis apparatus 204 may assign a $1.00 minimum bid 216 to each travel product in the matching travel products 224. In turn, minimum bid 216 may provide a “baseline” value that allows all travel products 224 matching the query to participate in the auction.

Next, analysis apparatus 204 may enable sponsoring of content in search results 226 by accepting additional bids 218 on travel products 224 from the suppliers. Additional bids 218 may be used to increase the visibility of one or more matching travel products 224 in search results 226 and/or include one or more travel products 224 that would otherwise not have matched search parameters 214 in search results 226.

In particular, additional bids 218 may be placed on various attributes associated with the search parameters 214, search results 226, and/or travel products 224. This concept is an extension of conventional advertising auctions that typically allow for bidding only on user actions, such as search queries. Additional bids 218 may be placed on a specific type of travel product (e.g., flights, hotels, rental cars, cruises, tours, travel packages, etc.), as well as a set of travel products associated with a supplier (e.g., the inventory of an airline, rental car company, cruise line, hotel group, tour operator, and/or travel agency). Additional bids 218 may also be placed on specific locations associated with the travel products, such as origins, destinations, origin-destination pairs, airports, hotel locations, tour or cruise itineraries, and/or routes. Furthermore, additional bids 218 may be placed on schedule-based attributes, such as departure dates, arrival dates, departure or arrival time segments (e.g., early morning, morning, early afternoon, afternoon, evening, night, redeye, etc.), total travel times, numbers of stops, lengths of stops, and/or trip durations. In other words, a portion of additional bids 218 may be associated with attributes of travel products 224 that exactly match search parameters 214 of the user's query.

Additional bids 218 may also be placed on attributes of travel products 224 that do not exactly match search parameters 214. Such additional bids 218 may include bids on schedule-related attributes that lie outside search parameters 214, such as travel dates that are one to three days earlier or later than the user's specified travel dates, departure or arrival times that are slightly earlier or slightly later than the user's specified departure or arrival time segments, and/or cruise or tour lengths that are slightly shorter or slightly longer than those requested by the user. Additional bids 218 may also expand the locations (e.g., origins, destinations, hotel locations, rental car locations, tour locations, cruises, etc.) in search parameters 214 to pre-defined radiuses (e.g., 50 miles) of locations specified in search parameters 214. Additional bids 218 may further allow violation of user-set filters 228 within set margins and/or ordering of search results 226 in a way that violates the user's sort option.

If additional bids 218 are made on one or more travel products 224 that violate search parameters 214, the travel product(s) may be added to the set of matching travel products 224. The added travel product(s) may also be distinguished from matching travel products 224 within search results 226. For example, the added travel product(s) may be color-coded, highlighted, marked with a symbol, and/or otherwise set apart from matching travel products 224 to allow the user to recognize the added travel product(s) as non-exact matches of search parameters 214. Similarly, attributes of the added travel product(s) that violate search parameters 214 may be explicitly stated to facilitate the user's consideration of the added travel product(s).

In addition, the added travel product(s) may be associated with a limited number of violations and/or a margin of violation for the violated search parameter(s). For example, analysis apparatus 204 may limit the inclusion of travel products 224 that violate search parameters 214 in search results 226 to a pre-specified number to ensure that the majority of search results 226 match the user's query. Analysis apparatus 204 may also ensure that each violation stays within a certain margin of the dates (e.g., up to 3 days), times (e.g., up to 1 hour), locations (e.g., up to 50 miles), total travel times (e.g., up to 5 hours), and/or other search parameters 214 of the query and/or filters 228 associated with search results 226.

Such inclusion of travel products with small violations of search parameters 214 may provide a “broad match” feature that increases the value of the query and/or search results 226 to both the user and suppliers of travel products 224. For example, the user may include an origin, a destination, and specific departure and arrival dates during a search for flights. An airline may have an almost-sold-out flight between the origin and destination on the specified departure date at a high price. On the other hand, the airline may have plenty of seats and a significantly cheaper price for the same flight the day before the specified departure date. If the airline bids on travel dates that do not match the travel dates in the query, the cheaper flight may be shown in search results 226 to the user. In turn, the user may be given the opportunity to spend less on travel between the origin and destination, and the airline may fill seats on a slowly selling flight.

Additional bids 218 may also be made on other attributes and/or features associated with use of travel reservation framework 102. Such attributes and/or features may include modifications to search parameters 214 after the user has received search results 226, resulting in a new search of travel products 224 matching the modified search parameters 214. Each new search may change the user's context for interacting with travel reservation framework 102, thus enabling context-based bidding by the suppliers. Such context-based bidding may be particularly useful if the user modifies one or more search parameters 214 to indicate his/her flexibility. For example, if the user changes the departure date of a flight search, travel reservation framework 102 may relax the three-day margin associated with violating departure dates and allow flights that depart more than three days before or after the original or modified departure date to be included in search results 226. Similarly, an airline may make or change additional bids 218 on departure dates farther away from the original departure date to facilitate inclusion of the departure dates in search results 226 for flexible travelers.

As described above, travel-reservation framework 102 may include functionality to perform multi-destination searches. To enable sponsorship of content related to the multi-destination searches, analysis apparatus 204 may allow additional bids 218 to be made on destination preferences and/or combinations of destination preferences and destinations appearing in search results 226. Such destination preferences may include regions (e.g., Europe), experiences (e.g., Romance), sub-regions (e.g., Germany), and/or refinements to other destination preferences (e.g., South America->Jungle/Amazon/Trekking).

First, a supplier may bid on the use of a destination with a destination preference. If the destination already matches the destination preference, the supplier's additional bid may improve the destination's position in the list of destinations in search results 226. If the destination does not match the destination preference, the supplier's additional bid may allow the destination to be displayed in search results 226 for the destination preference. For example, a destination of “Jamaica” may match a “Beach” destination preference but not a “South America” destination preference. As a result, bidding on the “Jamaica” destination with the “Beach” destination preference may increase the visibility of the destination in search results 226, and bidding on the “Jamaica” destination with the “South America” destination preference may allow the destination to violate the search parameter containing the destination preference.

A destination-based bid may additionally be tied to another destination that appears in search results 226 and/or a feature of search results 226. For example, an airline may bid on flights between San Francisco and Jamaica if Cancun appears in search results 226 and search parameters 214 include the “Beach” destination preference. This is a special case extending the conventional advertising auctions mentioned above, which typically allow for bidding only on user actions such as search queries. Here, one is allowed to bid on a search result or a combination of a search result, a user preference, a user action, and/or a user query. The departure and return dates of the flights may also be required to match the departure and return dates included in search parameters 214 to prevent the flights from deviating too much from search parameters 214.

Additional bids 218 associated with multi-destination searches may also be made on destinations added to search results 226. Because a user-added destination may represent a strong user preference for the destination, such “added destination” events may allow for more precise targeting of users. For example, a supplier may bid on travel itineraries with a destination of “Jamaica” if the added destination is “Cancun.”

Furthermore, additional bids 218 may be made to promote destination preferences and/or refinements. For example, an additional bid may be made on a “Scandinavia” refinement to the “Europe” destination preference to increase the visibility of “Scandinavia” within a set of refinements for “Europe.”

Additional bids 218 may be made on user preferences and/or social context. For example, user preferences for travel itineraries may include a preference for nonstop travel, a sensitivity to long travel times, a preference for highly reputable destinations, a preference for exotic destinations, a willingness to travel on a passport, a willingness to travel on a visa, a preference for traveler-friendly destinations, and/or a preference for domestic destinations. Such user preferences may be included in the user's profile, provided in the query, and/or otherwise obtained from the user. Consequently, a supplier may bid on travel itineraries associated with a destination (e.g., Manaus) given a destination preference (e.g., South America) and a user preference (e.g., exotic destinations) provided in a multi-destination search.

Social context items may include historical visits, check-ins, and/or travel frequencies by the user and/or the user's friends, family members, acquaintances, and/or other social network contacts. For example, a supplier may bid on flights to destinations to which the user's social network contacts have been. Similarly, the supplier may bid on flights to a destination if the user has been to the destination multiple times and/or has a tendency to travel to the same destinations.

As with multi-destination searches, additional bids 218 may also be used with the “alternative destinations” mechanism. For example, all additional bids 218 associated with multi-destination searches may also be used with multi-destination searches that are performed during use of the “alternative destinations” mechanism. Additional bids 218 may further be placed on the display of the second destination after the user selects the first destination in the “alternative destinations” mechanism. For example, an airline and/or other supplier may place additional bids 218 on flight departures between San Francisco and Jamaica if the query specifies an origin of San Francisco and a destination of Mexico and the user selects Cancun as the first destination in the “alternative destinations” mechanism.

Travel reservation framework 102 may also enable the use of additional bids 218 in biasing the selection of one of two destinations using the “alternative destinations” mechanism. Continuing with the above example, the supplier may sponsor an increase in the likelihood that Jamaica is selected over Cancun by the “alternative destinations” mechanism for purchase by the user.

After additional bids 218 are received, analysis apparatus 204 may calculate a set of quality scores 220 for travel products 224 and generate a ranking 222 of travel products 224 based on minimum bid 216, additional bids 218, and quality scores 220. Quality scores 220 may represent the relevance, quality, and/or performance of the corresponding travel products 224 with respect to search parameters 214. As a result, a travel product may have a high quality score if the travel product matches well with search parameters 214 and user preferences and a lower quality score if the travel product violates one or more search parameters 214 and/or user preferences or is otherwise less desirable (e.g., less convenient, more expensive, less reputable, lower quality, etc.).

To obtain ranking 222, analysis apparatus 204 may add minimum bid 216 to an additional bid for each travel product to obtain an overall bid for the travel product. For example, an additional bid b^{(r)}(c) on a piece of content c may be augmented with minimum bid 216 M to obtain an overall bid b(c)=b^{(r)}(c)+M. Next, analysis apparatus 204 may multiply the overall bid by the quality score of the travel product to obtain a rank value for the travel product. Continuing with the above example, b(c) may be multiplied by a quality score q(c) for the same piece of content to obtain the rank value (e.g., “adjusted bid”) for the piece of content.

Analysis apparatus 204 may then order travel products 224 by rank value, once rank values for all travel products 224 have been calculated. For example, analysis apparatus 204 may order travel products 224 by descending rank value. Once ranking 222 is generated, search results 226 may be displayed in results module 212 according to ranking 222. Thus, travel products with higher rank values may appear higher in search results 226, and travel products with lower rank values may appear lower in search results 226.

If multiple travel products 224 are to be grouped into a single element within search results 226, such as a destination “block” in a multi-destination search, the element's position in search results 226 may be based on the aggregated rank values of travel products 224 associated with the element. For example, a set of rank values may be calculated for individual flights to a destination, and the destination's overall rank value may be calculated as a sum, average, and/or other aggregate of the rank values of the individual flights. The destination's rank value may also be influenced by the number and coverage of the individual flights. As a result, bidding on a destination by a single airline with a few flights to the destination may result in a lower position for the destination than if additional bids 218 on the destination were received from multiple airlines with many flights to the destination. Within a given destination and/or destination “block,” flights to the destination may be ranked and/or ordered according to the rank values of the flights.

To charge suppliers for sponsoring travel products 224, analysis apparatus 204 may calculate a set of costs-per-action (CPAs) 232 for travel products 224. CPAs 232 may be based on additional bids 218 and/or quality scores 220. Using the above formulas, the CPA of content in position n may be calculated as:

max(q(n+1)b(n+1)/q(n)−M,0)

The CPA may thus be no greater than the additional bid and may be set to zero for content with a zero additional bid (e.g., unsponsored content).

Consequently, minimum bid 216 may be used to balance quality and/or relevance of search results 226 with sponsorship of search results 226. If minimum bid 216 is infinite, additional bids 218 do not affect the rank values of travel products 224, and placement of travel products 224 in search results 226 may be based solely on quality scores 220 and/or user-selected sort options. If minimum bid 216 is zero, unsponsored content may not be included in search results 226, and sponsored content may be ranked based on both additional bids 218 and quality scores 220.

Those skilled in the art will appreciate that a supplier may use different additional bids 218 with different travel products in search results 226. In a conventional advertising auction, the supplier's bids may raise the CPAs of some of the supplier's content. For example, a first airline may bid $2.00 for a first flight in search results 226 and $1.50 for a second flight in search results 226, and a second airline may bid $1.00 for a third flight in search results 226. If all three flights have the same quality score, analysis apparatus 204 may calculate CPAs of $1.50, $1.00, and the reserve price of the auction for the first, second, and third flights, respectively.

To offset the potential increase in a supplier's CPAs 232 caused by the supplier's additional bids 218, a single CPA may be calculated for a subset of travel products 224 associated with additional bids 218 from the supplier based on the additional bid for a travel product from a different supplier that is next lowest in ranking 222 from the subset. As a result, the CPAs in the above example may be adjusted to $1.00, $1.00, and the reserve price for the first, second, and third flights, respectively.

CPAs 232 may then be used to charge the suppliers for promoting content in search results 226. For example, a supplier may be charged the CPA for a travel product in search results 226 if a user clicks on the travel product, completes a booking or purchase (e.g., purchase 230) of the travel product, and/or is redirected to a website and/or booking mechanism outside of travel reservation framework 102 for booking or purchase 230 of the travel product. In addition, CPAs 232 may vary based on the user actions for which the suppliers are charged. For example, a CPA for purchasing a travel product may be higher than a CPA for clicking on the travel product.

The combination of sponsored and unsponsored content in search results 226 may allow suppliers of travel products 224 to promote certain features and/or attributes of travel products 224 while keeping all travel products 224 as organic search results 226 in results module 212. At the same time, the participation of both sponsored and unsponsored content in an auction for selecting and ranking 222 search results 226 may ensure that high-quality unsponsored content remains visible in search results 226 and irrelevant sponsored content is omitted from search results 226. Finally, the “broad matching” of search parameters 214 to a subset of travel products 224 that violate search parameters 214 may facilitate the sale of such travel products by the suppliers of the travel products and allow the user to consider potentially better (e.g., cheaper, more convenient, higher quality) travel products without deviating too far from search parameters 214.

Those skilled in the art will appreciate that the system of FIG. 2 may be implemented in a variety of ways. First, presentation apparatus 202, analysis apparatus 204, search apparatus 206, and/or processing apparatus 208 may be provided by a single physical machine, multiple computer systems or electronic devices, one or more virtual machines, a grid, one or more databases, one or more filesystems, and/or a cloud computing system. In addition, presentation apparatus 202, analysis apparatus 204, search apparatus 206, and/or processing apparatus 208 may be implemented together or separately by one or more hardware and/or software components and/or layers.

Second, sponsored and unsponsored content may be combined in search results 226 in a number of ways. As mentioned above, minimum bid 216 may be used to balance sponsorship of travel products 224 with quality and/or relevance of travel products 224 in search results 226. Along the same lines, the placement and/or appearance of travel products 224 in search results 226 may be fine-tuned through adjustments in the calculation of quality scores 220, the enabling or disabling of additional bids 218 on various attributes of travel products 224 and/or search parameters 214, and/or rules associated with including travel products that violate search parameters 214 in search results 226.

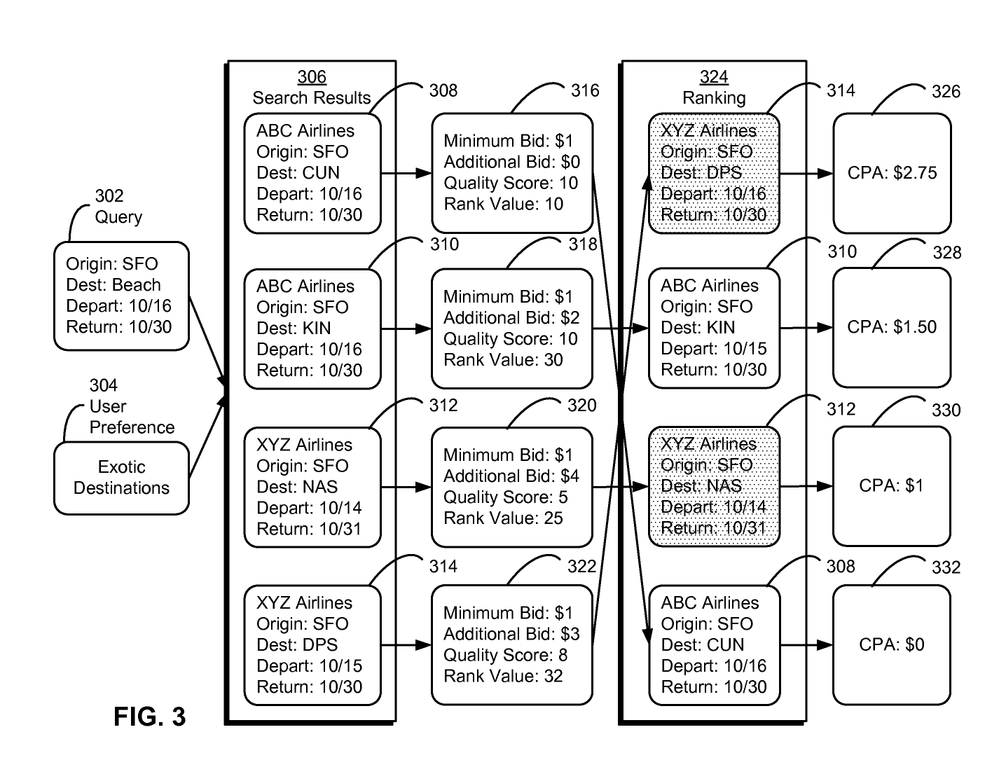

FIG. 3 shows the exemplary processing of a query 302 from a user in accordance with the disclosed embodiments. Query 302 includes a set of search parameters, such as an origin (e.g., “SFO”), a destination (e.g., “Beach”), a departure date (e.g., “10/16”), and a return date (e.g., “10/30”). Query 302 may also be accompanied by a user preference 304 for “Exotic Destinations.” Query 302 and user preference 304 may then be used to search flights and/or other travel itineraries for a user.

In particular, a search using query 302 and user preference 304 may return a set of search results 306 containing four travel products 308-314 (e.g., flights). Travel products 308-314 may be associated with two different suppliers having the same origin (e.g., “SFO”) as query 302 but differing in destination, departure dates, and/or return dates. For example, travel product 308 may have a supplier of “ABC Airlines,” a destination of “CUN,” and the same departure and return dates as query 302. Travel product 310 may have a supplier of “ABC Airlines,” a destination of “KIN,” and the same departure and return dates as query 302. Travel product 312 may have a supplier of “XYZ Airlines,” a destination of “NAS,” a departure date of “10/14,” and a return date of “10/31.” Travel product 314 may have a supplier of “XYZ Airlines,” a destination of “DPS,” a departure date of “10/15,” and the same return date as query 302. As a result, travel products 308-310 may match the search parameters of query 302, while travel products 312-314 may violate one or more search parameters (e.g., departure and/or return dates) of query 302.

Travel products 308-314 may also be associated with auction information 316-322 that is used to determine a ranking 324 of travel products 308-314. First, auction information 316-322 may include the same minimum bid of “$1” for all travel products 308-314. As described above, the minimum bid may allow all travel products 308-314 to participate in an auction for generating ranking 324 and providing travel products 308-314 to the user based on ranking 324. In addition, the minimum bid may be used to balance the effects of quality and/or relevance of travel products 308-314 and sponsorship of travel products 308-314 on ranking 324. For example, an increase in the minimum bid may offset the effects of sponsorship on ranking 324, while a decrease in the minimum bid may increase the effects of sponsorship on ranking 324.

Auction information 316-322 may also include additional bids, quality scores, and rank values for travel products 308-314. The additional bids may be made by suppliers associated with travel products 308-314 to promote travel products 308-314 in searches. The quality scores may be calculated based on the relevance of travel products 308-314 to query 302 and/or user preference 304, the quality of travel products 308-314, and/or the performance of travel products 308-314 in searches with similar search parameters to query 302. Each rank value (e.g., “adjusted bid”) may be calculated by adding the minimum bid to the additional bid for the corresponding travel product to obtain an overall bid for the travel product, then multiplying the overall bid by the quality score of the travel product.

For example, travel product 308 may have an additional bid of “$0,” a quality score of “10,” and a rank value of “10.” Travel product 308 may thus represent unsponsored content that is highly relevant to query 302. Travel product 310 may have an additional bid of “$2,” a quality score of “10,” and a rank value of “30.” Like travel product 308, travel product 310 may be highly relevant to query 302. However, the additional bid associated with travel product 310 may convert travel product 310 into sponsored content that is promoted above unsponsored content with the same quality score, such as travel product 308.

Travel product 312 may have an additional bid of “$4,” a quality score of “5,” and a rank value of “25.” The additional bid associated with travel product 312 may allow travel product 312 to be included in search results 306, despite violating the departure and return dates of query 302. On the other hand, the mismatch between the departure and return dates of travel product 312 and those of query 302 may result in a lower quality score for travel product 312. Finally, travel product 314 may have an additional bid of “$3,” a quality score of “8,” and a rank value of “32.” As with travel product 312, the additional bid on travel product 314 may allow travel product 312 to be included in search results 306, even though the departure date of travel product 312 does not match the departure date of query 302. Unlike travel product 312, travel product 314 may have a relatively high quality score because travel product 314 matches user preference 304 and/or only violates one search parameter of query 302 instead of two.

Travel products 308-314 may then be ordered by rank value in ranking 324. As a result, travel product 314 may appear first in ranking 324, followed by travel product 310, then travel product 312, and finally travel product 308. The combination of high quality scores and additional bids may allow travel products 314 and 310 to appear at the top of ranking 324. Conversely, the relatively low quality score of travel product 312 may cause travel product 312 to be placed third in ranking 324, despite having the highest additional bid of all travel products 308-314. Finally, the lack of an additional bid for travel product 308 may prevent travel product 308 from appearing at the top of ranking 324, while the high quality score of travel product 308 may allow travel product 308 to be included in search results 306 and ranking 324.

Travel products 308-314 may then be displayed to the user based on ranking 324. For example, travel products 308-314 may be shown within a user interface to the user in the order specified in ranking 324 (e.g., decreasing rank values). In addition, travel products 312 and 314 may be highlighted, color-coded, and/or otherwise distinguished from the other travel products 308 and 310 in the user interface to allow the user to recognize travel products 312 and 314 as non-exact matches to query 302.

A set of CPAs 326-332 may also be calculated for travel products 308-314. In particular, a CPA of a travel product may be calculated as the rank value of the next travel product in ranking 324 divided by the quality score of the travel product, then with the minimum bid subtracted. As a result, CPA 326 of travel product 314 may be “$2.75,” CPA 328 of travel product 310 may be “$1.50,” CPA 330 of travel product 312 may be “$1,” and CPA 332 of travel product 308 may be “$0.” Each CPA 326-332 may be lower than or equal to the additional bid of the corresponding travel product 308-314. Moreover, CPA 332 may be zero to reflect the unsponsored state of travel product 308.

As shown in FIG. 3, nonzero CPAs 326-330 are associated with travel products 314, 310 and 312 from “XYZ Airlines,” “ABC Airlines,” and “XYZ Airlines,” respectively. Because one supplier's CPA 328 is in between CPAs 326 and 330 of another supplier, the suppliers may be charged CPAs 326-330 of the corresponding travel products 314, 310, and 312. However, if “XYZ Airlines” had two CPAs of “$2.75” and “$1.50” and “ABC Airlines” had a CPA of “$1,” both CPAs of “XYZ Airlines” may be set at “$1.50” to prevent “XYZ Airlines” from paying an increased CPA on a travel product after providing an additional bid on another travel product in the same set of search results 306.

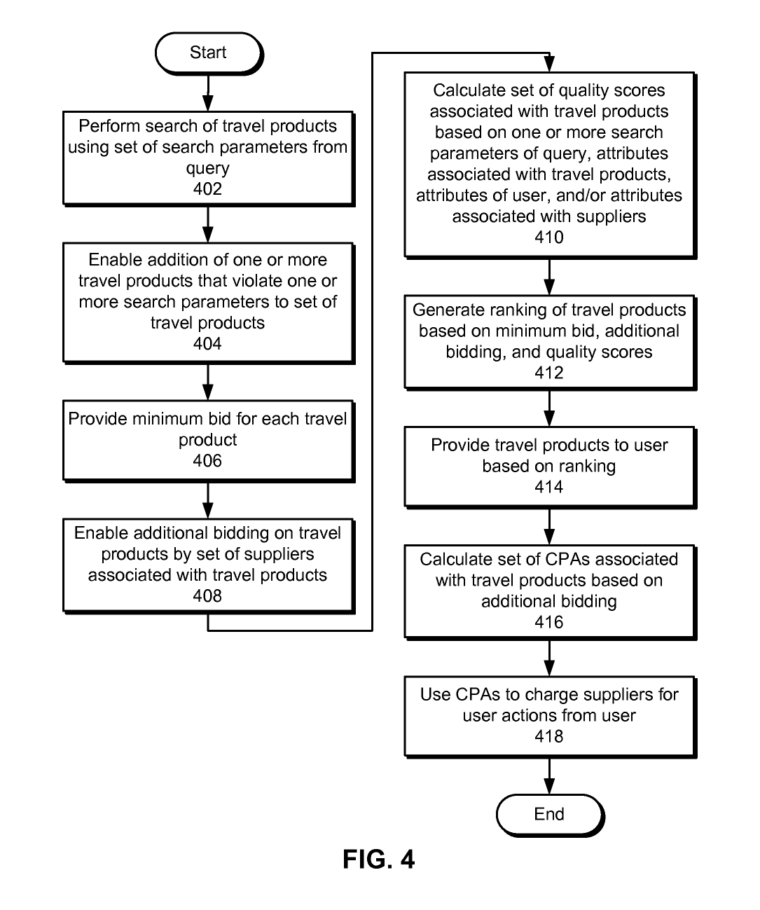

FIG. 4 shows a flowchart illustrating the processing of a query from a user in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of travel products matching the query is obtained. To obtain the travel products, a search of the travel products is performed using a set of search parameters from the query (operation 402). For example, the search may be performed with one or more travel databases for travel products that match an origin, a destination, a location, a set of travel dates, one or more date ranges, one or more travel times, one or more travel time segments, a price or price range, a schedule, a supplier, a class of service, a type of travel product, and/or other search parameters.

Moreover, the addition of one or more travel products that violate one or more search parameters to the set of travel products may be enabled (operation 404). For example, the added travel products may violate the location(s), dates, and/or schedule-based parameters associated with the query. The added travel products may also be associated with a limited number of violations and/or a margin of violation for the violated search parameter(s). For example, no more than three travel products that violate the search parameters may be added to the set of travel products, and each added travel product may be required to stay within a certain range of dates, times, and/or distances from those specified in the search parameters. Such limitations on the number and margins of violations may be enforced before the travel products are provided to the user, as described below.

Next, a minimum bid is provided for each travel product (operation 406), and additional bidding on the travel products by a set of suppliers associated with the travel products is enabled (operation 408). The minimum bid may allow all travel products to participate in an auction for inclusion and/or placement in search results of the search, while the additional bidding may enable sponsorship of travel products by the suppliers. The additional bidding may be associated with a subset of the travel products associated with a supplier (e.g., the inventory of the supplier, marketing carrier, operating carrier, validating carrier, etc.), an origin, a destination, a route (e.g., flight route, tour route, etc.), a schedule (e.g., departure time, arrival time, layover times, time segments, etc.), and/or a date (e.g., departure date, return date, stopover date, date range, etc.). The additional bidding may also be associated with a travel product type (e.g., flight, hotel, cruise, rental car, tour, travel package, etc.), a user preference (e.g., flight duration, distance, number of stops, class of service, level of quality, rating, etc.), and/or a user action (e.g., addition or removal of travel products in search results). The additional bidding may further be associated with a destination preference (e.g., region, experience, sub-region, event, list, refinement, etc.) and/or an alternative destination (e.g., second destination in an “alternative destinations” mechanism). The additional bidding may be based on a modification to the query (e.g., modification of one or more search parameters) and/or a search parameter of the query. Finally, the additional bidding may be placed on other attributes associated with booking travel, such as a traveler type (e.g., adult, child, senior) and/or an amount of inventory (e.g., number of seats remaining).

A set of quality scores associated with the travel products is also calculated based on one or more search parameters of the query, attributes associated with the travel products, attributes of the user, and/or attributes associated with the suppliers (operation 410). For example, the quality scores may be based on the relevance of the travel products to the search parameters and/or the user's preferences, the quality of the travel products (e.g., price, convenience, star rating, user rating, reputation, etc.), and/or the performance of the travel products (e.g., click-through rates, purchase rates, etc.) in similar queries.

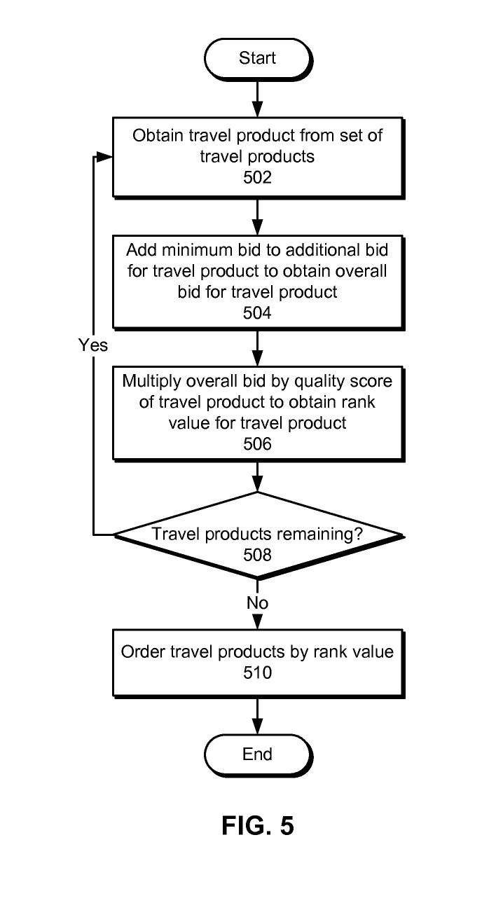

A ranking of the travel products is then generated based on the minimum bid, additional bidding, and quality scores (operation 412). Generating rankings of travel products is described in further detail below with respect to FIG. 5. The travel products are provided to the user based on the ranking (operation 414), and a set of CPAs associated with the travel products is calculated based on the additional bidding (operation 416). For example, the travel products may be displayed to the user in the order specified by the ranking. Prior to displaying the travel products, the travel products may optionally be filtered to reduce the number of travel products that violate search parameters of the query and/or any travel products that violate one or more search parameters by more than a pre-specified margin. The CPAs may then be calculated using the minimum bid, additional bidding, and/or quality scores. In addition, a CPA for a subset of the travel products associated with additional bids from a first supplier may be calculated based on an additional bid for a travel product from a second supplier that is next lowest in the ranking from the subset of the travel products. Such use of the same CPA with the subset of the travel products may prevent the first supplier from providing additional bids within the subset that increase the CPAs of other travel products in the subset.

Finally, the CPAs are used to charge the suppliers for user actions from the user (operation 418). For example, a supplier may be charged the CPA for a travel product after the user clicks on the travel product, books or purchases the travel product, and/or is redirected to another mechanism for booking and/or purchasing the travel product.

FIG. 5 shows a flowchart illustrating the process of generating a ranking of travel products in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a travel product from the set of travel products to be ranked is obtained (operation 502). The travel product may be a flight, a hotel, a rental car, a cruise, a tour, and/or a travel package. Next, a minimum bid is added to an additional bid for the travel product to obtain an overall bid for the travel product (operation 504). For example, a $1.00 minimum bid may be added to a $2.00 additional bid for the travel product to obtain an overall bid of $3.00 for the travel product. On the other hand, if the travel product does not have an additional bid (e.g., the travel product is unsponsored), the additional bid may be set to $0, and the minimum bid may be used as the overall bid.

The overall bid is then multiplied by the quality score of the travel product to obtain a rank value for the travel product (operation 506). For example, a $3.00 overall bid may be multiplied by a quality score of 7 to obtain a rank value (e.g., “adjusted bid”) of 21 for the travel product.

The process may be repeated for remaining travel products (operation 508) in the set of travel products. For each travel product, the rank value is calculated using the same minimum bid, any additional bid associated with the travel product, and the quality score of the travel product (operations 502-506). After the rank value has been calculated for all travel products in the set, the travel products are ordered by the rank value (operation 510). For example, the travel products may be ordered by decreasing rank value so that travel products with higher additional bids and/or quality scores appear at the top of the ranking and travel products with lower additional bids and/or quality scores appear lower in the ranking.

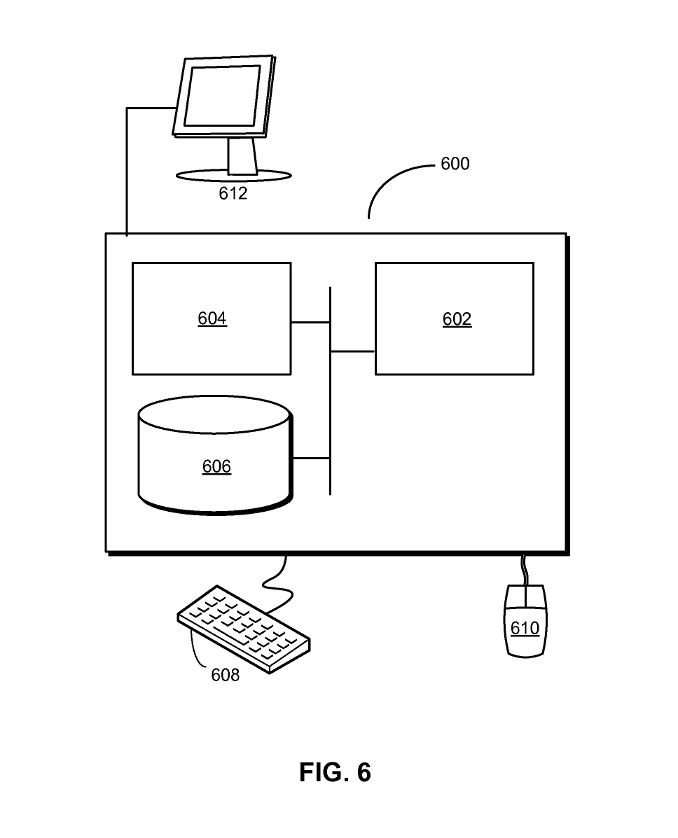

FIG. 6 shows a computer system 600 in accordance with an embodiment. Computer system 600 may correspond to an apparatus that includes a processor 602, memory 604, storage 606, and/or other components found in electronic computer systems. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, FIG. 6 provides a system for processing a query from a user. The system may include a search apparatus that obtains a set of travel products matching the query. The system may also include an analysis apparatus that provides a minimum bid for each of the travel products and enables additional bidding on the travel products by a set of suppliers associated with the travel products. Next, the analysis apparatus may generate a ranking of the travel products based on the minimum bid, the additional bidding, and a set of quality scores associated with the travel products. Finally, the system may include a presentation apparatus that provides the travel products to the user based on the ranking.

In addition, one or more components of computer system 600 may be remotely located and connected to the other components over a network. Portions of the present embodiments (e.g., presentation apparatus, analysis apparatus, search apparatus, processing apparatus, etc.) may also be located on different nodes of a distributed system that implements the embodiments. For example, the present embodiments may be implemented using a cloud computing system that processes queries for travel products from a set of remote users by presenting both sponsored and unsponsored content in search results associated with the queries.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for processing a query from a user, comprising:
obtaining a set of travel products matching the query;
providing a minimum bid for each of the travel products;
enabling additional bidding on the travel products by a set of suppliers associated with the travel products;
generating a ranking of the travel products based on the minimum bid, the additional bidding, and a set of quality scores associated with the travel products; and
providing the travel products to the user based on the ranking.

2. The computer-implemented method of claim 1, further comprising:
calculating a set of costs-per-action (CPAs) associated with the travel products based on the additional bidding by the set of suppliers.

3. The computer-implemented method of claim 2, wherein calculating the set of CPAs associated with the travel products based on the additional bidding by the set of suppliers involves:
calculating a cost-per-action (CPA) for a subset of the travel products associated with additional bids from a first supplier based on an additional bid for a travel product from a second supplier that is next lowest in the ranking from the subset of the travel products.

4. The computer-implemented method of claim 1, further comprising:
calculating the set of quality scores based on one or more search parameters of the query, one or more attributes associated with the travel products, one or more attributes of the user, or one or more attributes associated with the suppliers.

5. The computer-implemented method of claim 1, wherein obtaining the set of travel products matching the query from the user involves:
performing a search of the travel products using a set of search parameters from the query; and
enabling addition of one or more travel products that violate one or more of the search parameters to the set of travel products.

6. The computer-implemented method of claim 5, wherein the addition of the one or more travel products that violate the one or more of the search parameters is associated with at least one of:
a limited number of violations; and
a margin of violation.

7. The computer-implemented method of claim 1, wherein generating the ranking of the travel products based on the minimum bid, the additional bidding, and the set of quality scores involves:
for each travel product from the set of travel products:
adding the minimum bid to an additional bid for the travel product to obtain an overall bid for the travel product; and
multiplying the overall bid by a quality score of the travel product to obtain a rank value for the travel product; and
ordering the travel products by the rank value.

8. The computer-implemented method of claim 1, wherein the query is associated with at least one of:
a set of destination preferences; and
a destination uncertainty.

9. The computer-implemented method of claim 1, wherein the additional bidding on the travel products is associated with at least one of:
a subset of the travel products associated with a supplier;
an origin;
a destination;
a route;
a schedule;
a date;
a travel product type;
a user preference;
a user action;
a destination preference;
an alternative destination;
a modification to the query; and
a search parameter of the query.

10. A system for processing a query from a user, comprising:
a search apparatus configured to obtain a set of travel products matching the query;
an analysis apparatus configured to:
provide a minimum bid for each of the travel products;
enable additional bidding on the travel products by a set of suppliers associated with the travel products; and
generate a ranking of the travel products based on the minimum bid, the additional bidding, and a set of quality scores associated with the travel products; and
a presentation apparatus configured to provide the travel products to the user based on the ranking.

11. The system of claim 10, wherein the analysis apparatus is further configured to:
calculate a set of costs-per-action (CPAs) associated with the travel products based on the additional bidding by the set of suppliers.

12. The system of claim 10, wherein calculating the set of CPAs associated with the travel products based on the additional bidding by the set of suppliers involves:
calculating a cost-per-action (CPA) for a subset of the travel products associated with additional bids from a first supplier based on an additional bid for a travel product from a second supplier that is next lowest in the ranking from the subset of the travel products.

13. The system of claim 10, wherein obtaining the set of travel products matching the query from the user involves:
performing a search of the travel products using a set of search parameters from the query; and
enabling addition of one or more travel products that violate one or more of the search parameters to the set of travel products.

14. The system of claim 10, wherein generating the ranking of the travel products based on the minimum bid, the additional bidding, and the set of quality scores involves:
for each travel product from the set of travel products:
adding the minimum bid to an additional bid for the travel product to obtain an overall bid for the travel product; and
multiplying the overall bid by a quality score of the travel product to obtain a rank value for the travel product; and
ordering the travel products by the rank value.

15. The system of claim 10, wherein the query is associated with at least one of:
a set of destination preferences; and
a destination uncertainty.

16. A non-transitory computer-readable storage medium storing instructions that when executed by a computer cause the computer to perform a method for processing a query from a user, the method comprising:
obtaining a set of travel products matching the query;
providing a minimum bid for each of the travel products;
enabling additional bidding on the travel products by a set of suppliers associated with the travel products;
generating a ranking of the travel products based on the minimum bid, the additional bidding, and a set of quality scores associated with the travel products; and
providing the travel products to the user based on the ranking.

17. The non-transitory computer-readable storage medium of claim 16, wherein obtaining the set of travel products matching the query from the user involves:
performing a search of the travel products using a set of search parameters from the query; and
enabling addition of one or more travel products that violate one or more of the search parameters to the set of travel products.

18. The non-transitory computer-readable storage medium of claim 16, wherein generating the ranking of the travel products based on the minimum bid, the additional bidding, and the set of quality scores involves:
for each travel product from the set of travel products:
adding the minimum bid to an additional bid for the travel product to obtain an overall bid for the travel product; and
multiplying the overall bid by a quality score of the travel product to obtain a rank value for the travel product; and
ordering the travel products by the rank value.

19. The non-transitory computer-readable storage medium of claim 16, wherein the query is associated with at least one of:
a set of destination preferences; and
a destination uncertainty.

20. The non-transitory computer-readable storage medium of claim 16, wherein the additional bidding on the travel products is associated with at least one of:
a subset of the travel products associated with a supplier;
an origin;
a destination;
a route;
a schedule;
a date;
a travel product type;
a user preference;
a user action;
a destination preference;
an alternative destination;
a modification to the query; and
a search parameter of the query.
